(19) United States
(12) Patent Application Publication
(10) Pub. No.: US 2010/0260451 A1
(43) Pub. Date: Oct. 14, 2010

(54) THRUST BEARING HAVING IMPROVED ROLLING PINS AND LEVELING PLATE ELEMENTS

(76) Inventor: Joseph J. Wilkes, Holland, PA (US)

Correspondence Address: The Belles Group, P.C., 1518 Walnut Street, Suite 1706, Philadephia, PA, 19102, US

(21) Appl. No.: 12/423,696

(22) Filed: Apr. 14, 2009

(51) Int. Cl. F16C 19/30

(52) U.S. Cl. 384/619

(57) ABSTRACT

A thrust bearing having improved rolling pins and/or leveling plates that reduce wear and/or the size of the thrust bearing. In one aspect, the rolling pins have a substantially smaller radius of curvature than the surfaces of the lower leveling plates in which they nest. In another aspect, a leveling plate is used that has a substantially planar surface that contacts the rolling pins. In still another aspect, the rolling pins have a transverse cross-section having non-uniform radius of curvature. In yet another embodiment, the rolling pins have a transverse cross-section having a minor axis and a major axis.

### FIELD OF THE INVENTION

The present invention relates generally to bearings for retaining a rotating shaft, and specifically to thrust bearings having tiltable bearing shoes. The present invention is applicable to both lubricated and non-lubricated bearing types and the inventive concepts can be applied to any type of bearing arrangement.

### BACKGROUND OF THE INVENTION

Thrust bearing are well known for use with high speed rotating shafts and rotating collars. Thrust bearings typically retain rotating shafts in an axial direction of the shaft while journal bearings retain rotating shafts in a radial direction of the shaft. A shaft that is to be axially supported for rotation by a thrust bearing typically has a radially extending collar or flange providing a bearing surface that interfaces with the shoes of the thrust bearing. A lubricant may be supplied to the shoes so as to reduce frictional wear between the collar of the shaft and the bearing shoes.

In a typical thrust bearing, the bearing shoes are supported in a circular array and rest atop overlapping pivotal rockers, commonly referred to as leveling plates, that transmit forces between each other to equalize and uniformly distribute the load imposed upon them by the rotating shaft or the rotating collar. The bearing shoes are free to tilt to a limited extent so as to develop a wedge-shaped film of lubricant that supports the load and reduces unwanted friction and heat build-up. The load on each bearing shoe is inversely proportional to the oil film thickness squared. To equalize the load, the leveling plates lower an overloaded bearing shoe and simultaneously raise and under loaded bearing shoe. Since the leveling plates are in contact and interact with each other, unbalanced forces are transmitted through the leveling plates until equilibrium is reached.

Under actual operating conditions, a thrust bearing is never loaded perfectly, even though, theoretically, its load should be equalized due to the force distributing interactions between the leveling plates. Even though the leveling plates are constantly working and interacting with one another to distribute the load, applicant has discovered that the existing designs of leveling plates have been found to be inferior due primarily to friction between the contacting areas of adjacent plates and, thus, are a substantial source of wear.

In one existing design of thrust bearings, the leveling plates take the form of upper and lower leveling plates that overlap with one another. A radially extending convex ridge is integrally machined into either a lower surface of the upper leveling plate and/or an upper surface of the lower leveling plate for surface contact with tie opposing one of the upper and/or lower leveling plates. The radially extending convex ridge acts as a rocker element upon which the upper and lower leveling plates are allowed to tilt with respect to another so as to equalize the load imparted by the shaft onto the bearing shoes. The relative contact between the upper and lower leveling plates along the rocker element has been discovered to be a substantial source of wear for both the upper and lower leveling plates, resulting in a shortened life cycle of the thrust bearing.

In an attempt to remedy this problem, thrust bearings have been developed that replace the integrally formed convex ridge with a separate rolling pin that is “sandwiched” between the upper and lower leveling plates. These rolling pins nest within arcuate grooves formed into the upper and lower leveling plates which help retain the rolling pins in position. The rolling pines of these existing thrust bearings have a circular transverse cross section having a uniform radius of curvature that is approximately equal to the radius of curvature of the arcuate grooves in the upper and lower leveling plates. While the use of rolling pins has improved the life cycle of thrust bearings by producing rolling contact between the contact surfaces between the upper and lower leveling plates (via the rolling pin). However, it has been discovered by the applicant that the contact areas between the rolling pins and the upper and lower leveling plates is still experiencing substantial wear and, thus, tends to be a source of failure that limits the life cycle of the thrust bearing. This wear, and eventual frictional force breakdown, require maintenance and repair, thus requiring down time of the machines on which they are used.

A further drawback of existing designs of thrust bearings that utilize rolling pins is the increased height that results from the stack of the lower leveling plates, the rolling pins, and the upper leveling plates results. This increased height imparts limitations n the use of such thrust bearings in machinery where space is limited.

It will be appreciated that there is a need for a thrust bearing assembly that is less subject to wear, requires less maintenance, and has a reduced height dimension. It will also be appreciated that there is a need for a thrust bearing that is less susceptible to vibration and which may also be used in both lubricated and non-lubricated environments.

### SUMMARY OF THE INVENTION

It is an object of the present invention to provide a thrust bearing.

Another object of the present invention is to provide a thrust bearing having rolling pins that have a longer life cycle.

Yet another requires object of the present invention is to provide a thrust bearing having rolling pins that reduces wear on the upper and/or lower leveling plates.

Still another object of the present invention is to provide a thrust bearing having rolling pins that requires less maintenance and/or machine downtime.

A further object of the present invention is to provide a thrust bearing having rolling pins that increase rolling contact between the rolling pin and the upper and/or lower leveling plates.

A yet further object of the present invention is to provide a thrust bearing having rolling pins that has a decreased height.

These and other objects are met by the present invention, which is a thrust bearing having improved design of the rolling pins and/or the upper and/or lower leveling plates. In one aspect, the invention is a thrust bearing wherein the relative radius curvature between the rolling pins and the arcuate grooves in which the rolling pins nest is selected to minimize wear and/or increase rolling contact between surfaces. According to this aspect, the invention can be a thrust bearing for axially retaining a rotating shaft having a flange comprising: a base ring having a central opening having an axis; a plurality of upper leveling plates, each upper leveling plate having a body and upper flanges extending from opposite lateral sides of the body of the upper leveling plate, each of the upper flanges having a bottom surface; a plurality of lower leveling plates, each lower leveling plate having a body and lower flanges extending from opposite lateral sides of the body, each of the lower flanges having an arcuate groove formed into a top surface of the lower flange, the arcuate channels having a first radius of curvature; the upper and lower leveling plates arranged in an alternating manner atop the base ring so as to circumferentially surround the central opening so that the upper flanges of the upper leveling plates overlap the lower flanges of the lower leveling plates in a spaced apart manner, the bottom surfaces of the upper flanges opposing the top surfaces of the lower flanges, the lower leveling plates being tiltably mounted to the base ring; a plurality of rolling pins having a second radius of curvature, the second radius of curvature being substantially less than the first radius of curvature, the rolling pins freely resting within the arcuate grooves of the lower flanges and being in rolling contact with the bottom surfaces of the upper flanges; and a plurality of shoes having a working surface for bearing contact with the flange of the shaft, the shoes circumferentially surrounding the central opening and located atop the lower and/or upper leveling plates. In one embodiment, the ratio of said first radius of curvature to said second radius of curvature is preferably greater than 1.2:1 and more preferably 2:1.

In another aspect, the invention is a thrust bearing having wherein the portion of the upper leveling plate that is in contact with the rolling pin is designed to minimize wear and/or increase rolling contact between the upper leveling plate and the rolling pin. Unlike existing thrust bearings that utilize an arcuate groove in the upper leveling plate to receive and contact the rolling pin, this portion of the upper leveling plate in this aspect of the invention is a substantially planar surface. According to this aspect of the invention, the invention can be a thrust bearing for axially retaining a rotating shaft having a flange comprising: a base ring having a central opening having an axis; a plurality of upper leveling plates, each upper leveling plate having a body and upper flanges extending from opposite lateral sides of the body of the upper leveling plate, each of the upper flanges having a substantially planar bottom surface; a plurality of lower leveling plates, each lower leveling plate having a body and lower flanges extending from opposite lateral sides of the body, each of the lower flanges having a groove formed into a top surface of the lower flange; the upper and lower leveling plates arranged in an alternating manner atop the base ring so as to circumferentially surround the central opening so that the upper flanges of the upper leveling plates overlap the lower flanges of the lower leveling plates so that the substantially planar bottom surfaces of the upper flanges oppose the top surfaces of the lower flanges in a spaced-apart manner, the lower leveling plates being tiltably mounted to the base ring; a plurality of rolling pins freely resting within the grooves of the lower flanges and being in rolling contact with the substantially planar bottom surfaces of the upper flanges; and a plurality of shoes having a working surface for bearing contact with the flange of the shaft, the shoes circumferentially surrounding the central opening and located atop the lower and/or upper leveling plates. In an alternative form, the bottom surface of the upper leveling plates may be a convex surface rather than substantially planar.

In yet another aspect, the invention is a thrust bearing having a rolling pin with an improved design. In this aspect, the rolling pin may have either a transverse cross section having a major axis and a minor axis, the major axis being greater than the minor axis, or a transverse cross section having an outside surface having a non-uniform radius of curvature. According to this aspect, the invention can be a thrust bearing for axially retaining a rotating shaft having a flange comprising: a base ring having a central opening having an axis; a plurality of upper leveling plates, each upper leveling plate having a body and upper flanges extending from opposite lateral sides of the body of the upper leveling plate, each of the upper flanges having a bottom surface; a plurality of lower leveling plates, each lower leveling plate having a body and lower flanges extending from opposite lateral sides of the body, each of the lower flanges having a top surface; the upper and lower leveling plates arranged in an alternating manner atop the base ring so as to circumferentially surround the central opening so that the upper flanges of the upper leveling plates overlap the lower flanges of the lower leveling plates so that the bottom surfaces of the upper flanges oppose the top surfaces of the lower flanges in a spaced-apart manner, the lower leveling plates being tiltably mounted to the base ring; a plurality of rolling pins having a transverse cross section having a major axis and a minor axis, the major axis being greater than the minor axis, the rolling pins positioned between the top surfaces of the lower flanges and the bottom surfaces of the upper flanges, the rolling pins being in rolling contact with the top and bottom surfaces of the lower and upper flanges; and a plurality of shoes having a working surface for bearing contact with the flange of the shaft, the pads circumferentially surrounding the central opening and located atop the lower and/or upper leveling plates.

In another form of this aspect, the invention can be a thrust bearing for axially retaining a rotating shaft having a flange comprising: a base ring having a central opening having an axis; a plurality of upper leveling plates, each upper leveling plate having a body and upper flanges extending from opposite lateral sides of the body of the upper leveling plate, each of the -upper flanges having a bottom surface; a plurality of lower leveling plates, each lower leveling plate having a body and lower flanges extending from opposite lateral sides of the body, each of the lower flanges having a top surface; the upper and lower leveling plates arranged in an alternating manner atop the base ring so as to circumferentially surround the central opening so that the upper flanges of the upper leveling plates overlap the lower flanges of the lower leveling plates so that the bottom surfaces of the upper flanges oppose the top surfaces of the lower flanges in a spaced-apart manner, the lower leveling plates being tiltably mounted to the base ring; a plurality of rolling pins having a transverse cross section having an outside surface having a non-uniform radius of curvature, the rolling pins positioned between the top surfaces of the lower flanges and the bottom surfaces of the upper flanges, the rolling pins being in rolling contact with the top and bottom surfaces of the lower and upper flanges; and a plurality of shoes having a working surface for bearing contact with the flange of the shaft, the pads circumferentially surrounding the central opening and located atop the lower and/or upper leveling plates.

It should be noted that one or more of the aforementioned aspects of this invention can be combined in a single thrust bearing. This will become apparent from the following detailed description of the drawings, which illustrate non-limiting embodiments of the present invention. Of course, the invention is not limited to the embodiments disclosed herein but can be applied in a wide variety of structural arrangements.

### BRIEF DESCRIPTION OF THE DRAWINGS

FIG. 1 is a top perspective view of a thrust bearing according to a first embodiment of the present invention.

FIG. 2 is an exploded view of the thrust bearing of FIG. 1.

FIG. 3A is a rear perspective view of an upper leveling plate of the thrust bearing of FIG. 1.

FIG. 3B is a front perspective view of the upper leveling plate of the thrust bearing of FIG. 1.

FIG. 4A is a front perspective view of a lower leveling plate of the thrust bearing of FIG. 1.

FIG. 4B is a rear perspective view of the lower leveling plate of the thrust bearing of FIG. 1.

FIG. 5 is a perspective view of one embodiment of a rolling pin of the thrust bearing of FIG. 1.

FIG. 6 is a bottom perspective view of a chamfered shoe support of the thrust bearing of FIG. 1.

FIG. 7A is a first top perspective view of a bearing shoe of the thrust bearing of FIG. 1.

FIG. 7B is a bottom perspective view of a bearing shoe of the thrust bearing of FIG. 1.

FIG. 8 is a top perspective view of a base ring of the thrust bearing of FIG. 1.

FIG. 9 is a top view of the thrust bearing of FIG. 1.

FIG. 10 is a cross sectional view of the thrust bearing of FIG. 9 taken along line B-B.

FIG. 11 is a cross sectional view of the thrust bearing of FIG. 9 take along line A-A.

FIG. 12 is a top perspective view of a thrust bearing according to a second embodiment of the present invention.

FIG. 13 is an exploded view of the embodiment shown in FIG. 12.

FIG. 14A is a rear perspective view of an upper leveling plate of the thrust bearing of FIG. 12.

FIG. 14B is a front perspective view of the upper leveling plate of the thrust bearing of FIG. 12.

FIG. 15 is a top view of the thrust bearing of FIG. 12.

FIG. 16 is a cross sectional view of the thrust bearing of FIG. 15 taken along line B-B.

FIG. 17 is a top perspective view of a thrust bearing according to a third embodiment of the present invention.

FIG. 18 is an exploded view of the thrust bearing of FIG. 17.

FIG. 19A is a rear perspective view of a lower leveling plate of the thrust bearing of FIG. 17.

FIG. 19B is a front perspective view of the lower leveling plate of the thrust bearing of FIG. 17.

FIG. 20A is a rear perspective view of an upper leveling plate of the thrust bearing of FIG. 17.

FIG. 20B is a front perspective view of the upper leveling plate of the thrust bearing of FIG. 17.

FIG. 21 is a perspective view of a rolling pin of the thrust bearing of FIG. 17.

FIG. 22 is a top view of the thrust bearing of FIG. 17.

FIG. 23 is a cross sectional view of the thrust bearing of FIG. 22 taken along line B-B.

FIG. 24 is a transverse cross-sectional view of the rolling pin of the thrust bearing of FIG. 17.

### DETAILED DESCRIPTION OF THE DRAWINGS

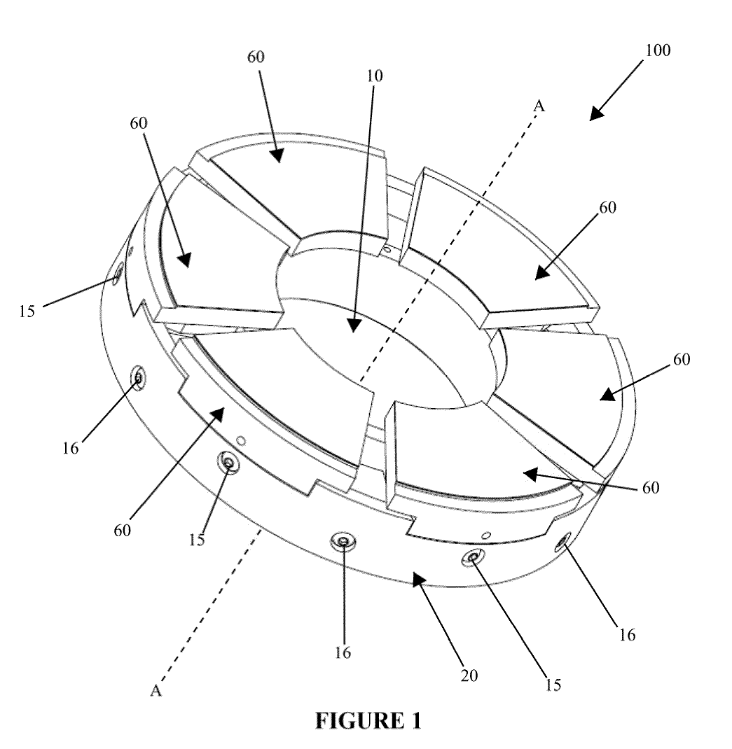

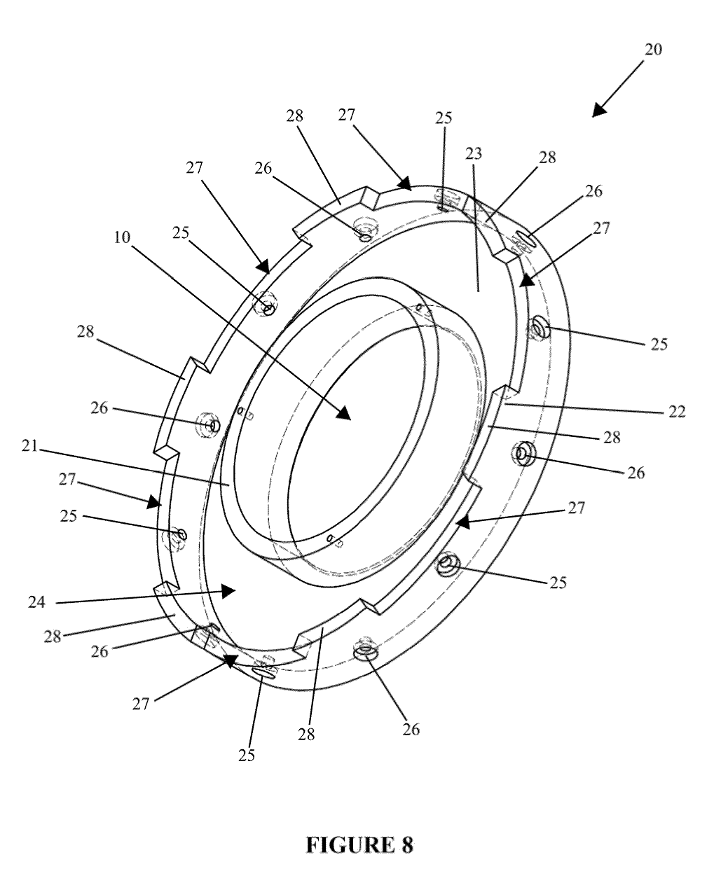

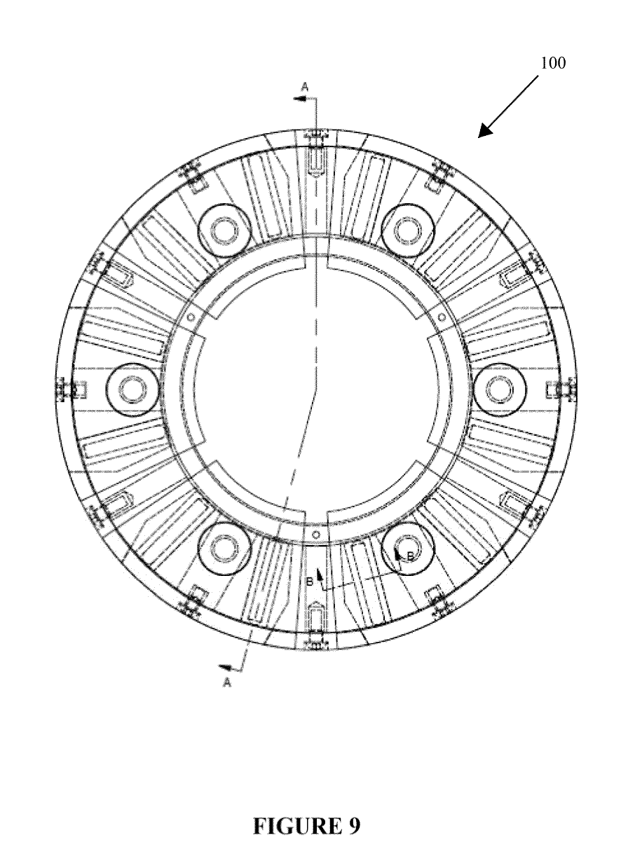

FIGS. 1-11 illustrate a thrust bearing 100 according to a first aspect of the present invention. As will be described in detail below, the thrust bearing 100 incorporates a rolling pin having a transverse cross-section having a radius of curvature that is substantially less than the radius of curvature of the groove in the leveling plate in which it nests. Other inventive aspects of the thrust bearing 100 will become apparent to those skilled in the art from the detailed discussion below and reference to the drawings.

The thrust bearing 100 can be used for axially retaining a rotating shaft (not illustrated) in any environment, machine or other construct. While the thrust bearing 100 is illustrated as generally ring-like structure, it is to be understood that the thrust bearing that can take on a wide variation of structural arrangements. For example, the thrust bearing 100 may be a plate-like assembly that does not contain a central hole. Moreover, while the thrust bearing 100 is discussed in terms of engaging a flange or collar of a shaft, it is to be understood that the elements of the shaft in now way limit the inventive concepts described herein. The thrust bearing 100 may engage other structures of the shaft or other equipment.

As used herein, terms such as radial, circumferential, and axial refer to directions relative to either the axis of the rotating of the shaft and/or the axis of a central hole of the thrust bearing 100. In many embodiments, the axis of the central hole of the thrust bearing 100 will be co-axial with the axis of the shaft it supports. These terms are used to relatively define the structural arrangement and cooperation of the elements of the thrust bearing 100 and are not to be considered as imparting additional and undue limitations to the claims.

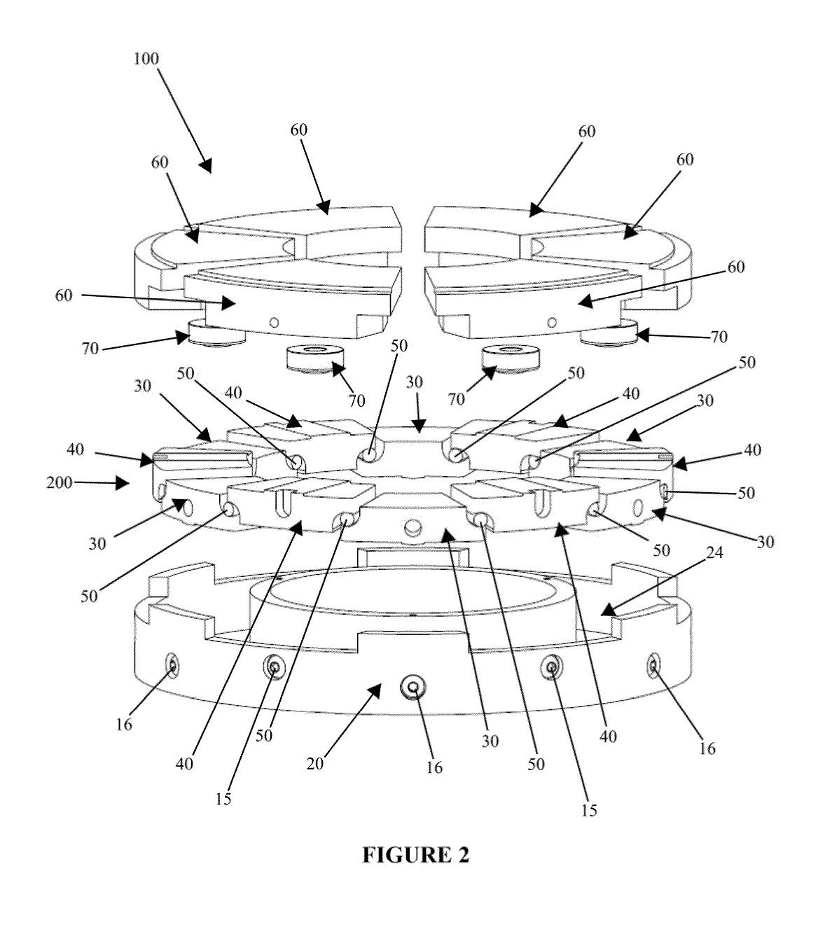

Referring now to FIGS. 1-2 concurrently, the thrust bearing 100 will be generally described. FIG. 1. illustrates the thrust bearing 100 in a fully assembled state while FIG. 2 illustrates the thrust bearing 100 in an exploded state so that its components are fully visible. The thrust bearing 100 is a ring-like assembly having a central hole 10 formed about an axis A-A. The central hole 10 has a circular shape but can, of course, be other shapes.

The thrust bearing 100 generally comprises a ring base 20, a plurality of lower leveling plates 30, a plurality of upper leveling plates 40, a plurality of rolling pins 50, a plurality of bearing shoes 60, and a plurality of chamfered bearing shoe supports 70. All of the components of the thrust bearing 100 are preferably fabricated of metal or other durable materials capable of withstanding high temperature and stress forces that are typically experienced by thrust bearings during use. The exact materials of construction for any bearing will be dictated by the end use and predicted forces to which the thrust bearing will be subjected. The components 20, 30, 40, 50, 60, 70 of the thrust bearing 100 can be constructed as a single structure or from multiple structures, and can be formed via a machining process, welding components together and/or combinations thereof.

The base ring 20 provides a base (or foundation) for the remaining components 30, 40, 50, 60, 70 of the thrust bearing 100. The assembly and structural cooperation of the components 20, 30, 40, 50, 60, 70 of the thrust bearing 100 in the assembled state will be described after the structural details of each component is explained below.

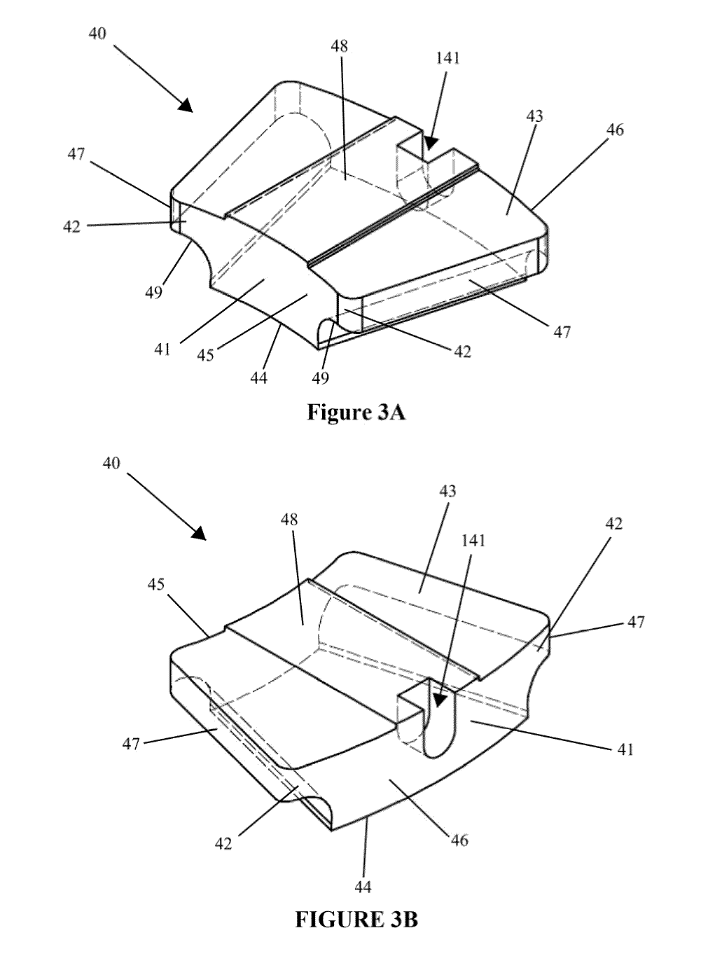

Referring now to FIGS. 3A and 3B concurrently, one of the upper leveling plates 40 is illustrated for exemplary purposes. The upper leveling plate 40 is an arcuate segment and comprises a top surface 43, a bottom surface 44, an inner arcuate surface 45, an outer arcuate surface 46, and lateral surfaces 47. The top surface 43 comprises a raised surface 48, which as will be explained in detail below, provides a surface upon which the chamfered shoe support 70 rests to tiltably support the bearing shoes 60.

The upper leveling plate 40 also comprises a main body 41 and upper flanges 42 extending laterally from the main body 41. While the main body has a thickness that is greater than the flanges 42 in the illustrated embodiment, the invention is not so limited. The flanges 42 and the body 41 may be the same thickness, thereby resembling a plate-like structure.

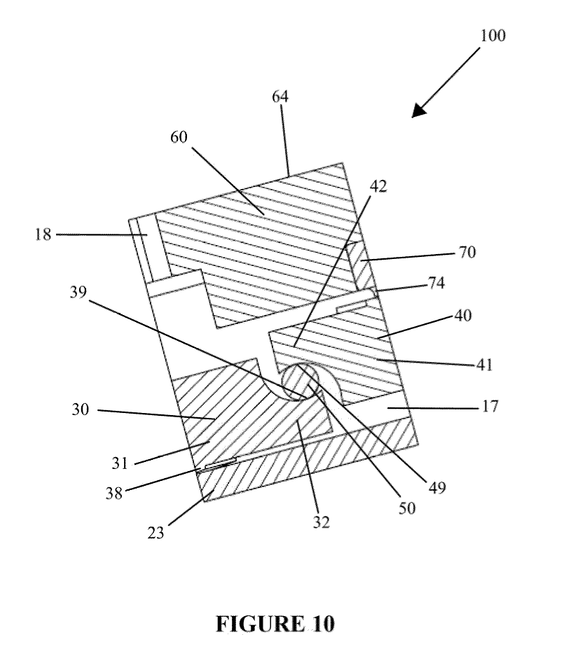

The bottom surfaces of the flanges 42 are formed so as to form arcuate grooves 49. Theoretically, the arcuate grooves 49 can also be considered to be formed into the both bottom surfaces of the flanges 42 and the side walls of the main body 41. The arcuate grooves 49 provide geometry on the upper leveling plate 40 in which the rolling pins 50 can nest when the thrust bearing 100 is assembled. The arcuate grooves 49 have a uniform radius of curvature (best visible in FIG. 10) and extend from the inner arcuate surface 45 to the outer arcuate surface 46 (i.e., the entire width of the leveling plate 40). The radius of curvature of the arcuate grooves 49 is specially selected to minimize and/or reduce wear between the rolling pins 50 and the leveling plates 30, 40. In some embodiments, however, the grooves 49 may not be uniformly arcuate in nature but may rather have a varying radius of curvature, a rectangular shape or another shape all together. In some embodiments, the flanges 42 may be free of grooves.

A notch 141 is centrally provided in the outer arcuate surfaces 46 of the main body 41 of the upper leveling plates 40 to receive the ends of the set screws 15 (FIG. 1) that threadily engage the base ring 20 when the thrust bearing 100 is assembled. The notch 141 has an open top end and a curved floor.

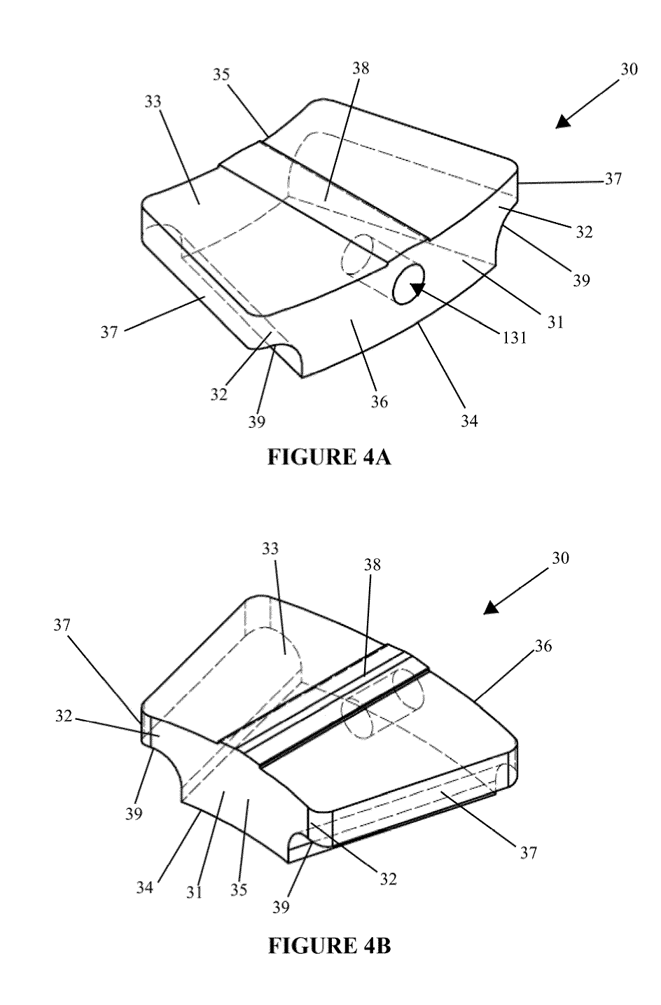

Referring now to FIGS. 4A and 4B concurrently, one of the lower leveling plates 30 is illustrated for exemplary purposes. The lower leveling plate 30 is illustrated upside-down so that its bottom surface 34 is visible. The lower leveling plate 30 is an arcuate segment and comprises a top surface 33, a bottom surface 34, an inner arcuate surface 35, an outer arcuate surface 36, and lateral surfaces 37. The bottom surface 34 comprises a rocker portion 38, which as will be explained in detail below, provides a structure for tiltably mounting the lower leveling plate 30 to the base ring 20. While rocker portion 38 is illustrated as a chamfered ridge, other geometries and/or structures can be used to ensure that the lower leveling plate 30 tilts/rocks with respect to the base ring 20. For example, a convex surface can be utilized. Moreover, the rocker element can be formed into or connected to the base ring 20 instead of the lower leveling plate 30.

The lower leveling plate 30 also comprises a main body 31 and lower flanges 32 extending laterally from the main body 41. While the main body 31 has a thickness that is greater than the flanges 32 in the illustrated embodiment, the invention is not so limited. The flanges 32 and the body 31 may be the same thickness, thereby resembling a plate-like structure.

The upper surfaces of the flanges 32 are formed so as to form arcuate grooves 39. Theoretically, the arcuate grooves 39 can also be considered to be formed into the both upper surfaces of the flanges 32 and the side walls of the main body 31. The arcuate grooves 39 provide geometry on the lower leveling plate 30 in which the rolling pins 50 can nest when the thrust bearing 100 is assembled. The arcuate grooves 39 have a uniform radius of curvature (best visible in FIG. 10) and extend from the inner arcuate surface 35 to the outer arcuate surface 36 (i.e., the entire width of the lower leveling plate 30). The radius of curvature of the arcuate grooves 39 is specially selected to minimize and/or reduce wear between the rolling pins 50 and the leveling plates 30, 40. This concept will be described in greater detail below. The radius of curvature of the arcuate grooves 39 of the lower leveling plates 30 may be the same as or different than the radius of curvature of the arcuate grooves 49 of the upper leveling plates 40. In the embodiment exemplified in FIGS. 1-11, the radius of curvature of the arcuate grooves 39 of the lower leveling plates 30 is substantially equal to the radius of curvature of the arcuate grooves 49 of the upper leveling plates 40.

A bore 131 is formed into the outer arcuate surfaces 36 of the main body 31 of the lower leveling plates 30 to receive the ends of the set screws 16 (FIG. 1) of the base ring 20 when the thrust bearing 100 is assembled.

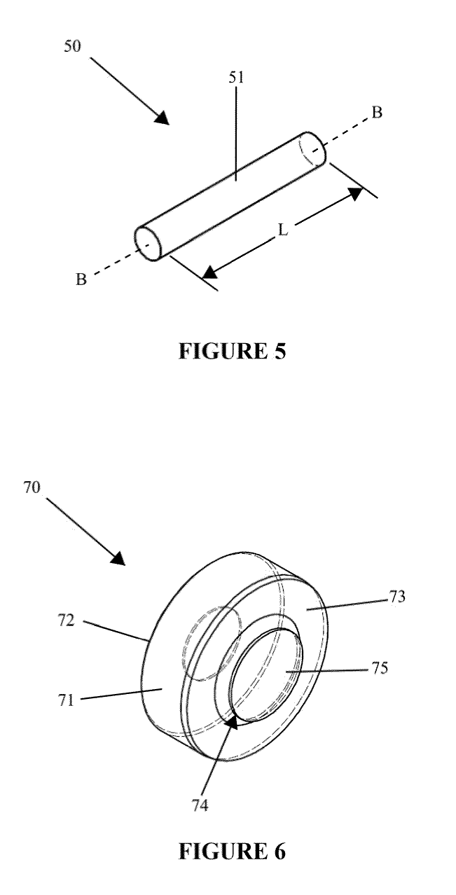

Referring now to FIG. 5, a rolling pin 50 used in the thrust bearing 100 is illustrated. The rolling pin 50 is an elongated cylindrical element that extends along axis B-B for a length L. The length L of the rolling pin 50 is preferably greater than its diameter and is substantially equal to the width of the lower leveling plate 30 (measured radially from the inner arcuate surface 35 to the outer arcuate surface 36). Of course, the invention is not so limited and the length L of the rolling pin 50 does not have to be equal to the width of the lower leveling plate 30 in other embodiments.

The rolling pin 50 has a circular transverse cross-section having a uniform radius of curvature along the outer surface 51. It has been surprisingly discovered that by making the radius of curvature of the rolling pin 50 substantially less than the radius of curvature of the arcuate grooves 39 of the lower leveling plates 30, the amount of wear at the contact points between the rolling pin 50 and the leveling plates 30, 40 is substantially reduced. The exact radius of curvature for the rolling pins 50 and the arcuate grooves of the lower leveling plates 30 will be dictated by the size of the thrust bearing 100 and the end use to which it is to be put. For purposes of the present invention, the numerical dimension of the radii of curvature of the arcuate grooves 39 and the rolling pins 50 is not important, it is their size relative to one another (i.e., their comparative ratio) that has been discovered to reduce wear and increase the life cycle. This mechanism of action will be described in greater detail below with respect to FIG. 10.

The rolling pin 50 can be constructed of metal or other suitable material as discussed above. However, in some embodiments, it may be preferable to construct the rolling pins 50 from a material having a hardness that is less than the hardness of the material from which the leveling plates 30, 40 are constructed. As a result, wear on the leveling plates 30, 40 may be reduced, requiring replacement of only the rolling pins 50 during a schedules routine maintenance. The invention, however, is not so limited and in other embodiments it may be preferred to construct the rolling pins 50 of the same material of the leveling plates 30, 40 or even of a harder material.

Referring now to FIG. 6, one of the shoe supports 70 is illustrated. The shoe support 70 has a general truncated cylindrical shape. The shoe support 70 comprises a top surface 72, a bottom surface 73, and an outer lateral wall surface 71 extending between the two surfaces 72, 73. The shoes support 70 comprises a rocker element 74 coupled to the bottom surface 73. The rocker element 74 comprises a convex outer surface 75 so as to form a generally dome-shaped structure that facilitates tiltable mounting of the bearing shoe 60 within the thrust bearing 100. While the rocker element 74 is illustrated as a dome-shaped structure, the rocker element 74 can be a chamfered ridge, a pivot, or any other structure that creates an interface capable of relative rocking/tilting between the components.

A slight bore or raised surface (not referenced) may be provided on the top surface 72 of the shoe support 70. The bore may receive a protuberance of the bearing shoe 60 when installed therein.

When the thrust bearing 100 is assembled, the shoe support 70 fits within a cavity formed into the bottom surface of the body of the bearing shoe 60 so that the rocker element 74 protrudes from the bottom surface of the bearing shoe 60. In this way, when the bearing shoes 60 are assembled into the thrust bearing 100, the bearing shoes 60 are tiltably/rockably supported atop the raised portion 48 of the upper leveling plate 40. While the shoe support 70 is exemplified as a separate component of the thrust bearing 100, it can be integrally formed or otherwise incorporated directly into the bearing shoe 60 or the upper and/or lower leveling plates 30, 40 if desired.

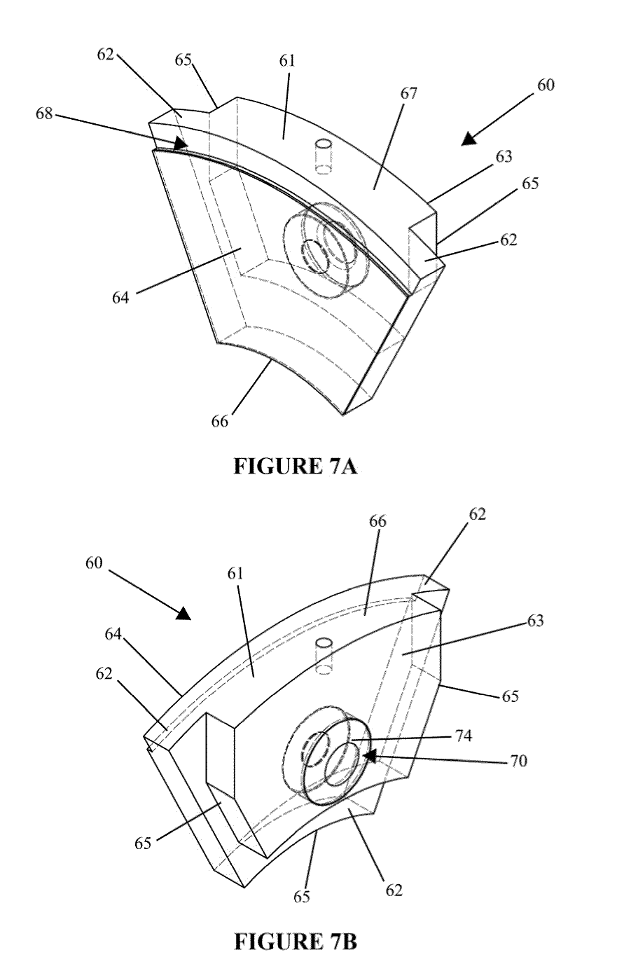

Referring now to FIGS. 7A and 7B concurrently, a bearing shoe 60 of the thrust bearing 100 is illustrated. The bearing shoe 60 is the structure designed to be in bearing contact with the flange or collar of the rotating shaft. The bearing shoe 60 comprises a main body portion 61 and a flange 62 laterally extending from the main body 61. The bearing shoe 60 is an arcuate segment having a bottom surface 63, a top surface 64, lateral surfaces 65, an inner arcuate surface 66 and an outer arcuate surface 67. The flange 62 extends from the lateral sides 63 and the outer arcuate surface 64 of the main body 61.

The top surfaces 64 of the bearing shoe 60 are the working surfaces of the thrust bearing 100 that are designed to be in bearing contact with the flange or collar of the rotating shaft. The top surface 64 of the bearing shoe 60 may be formed of the same material as the main body 61 of the bearing shoe 60 or may be constructed of a separate layer of low friction material different connected or applied to remainder of the bearing shoe 60. The top surface 64 may also be suitably contoured to ensure proper bearing contact with the shaft and/or to facilitate lubricant film formation. Such arrangements are known in the art and need no further discussion herewith.

The top surface 64 of the bearing shoe 60 is raised to ensure bearing contact with the shaft. As a result, an arcuate depression 68 is formed into the outer periphery of the bearing shoe 60.

The bearing shoe 60 receives the shoe support 70 within a cavity (or bore) formed into its bottom surface 63. The cavity/bore is sufficiently deep so that the main portion of the shoe support 70 fully nests within the main body 61 of the bearing shoe 60 and only the rocker 74 protrudes beyond the bottom surface 63 of the bearing shoe 60. The shoe support 70 is secured within the cavity of the bearing shoe 60 via a tight fit connection. Of course, other suitable means can be used to achieve the connection, such as adhesives, welding, anchors, fasteners, clamps, a snap-fit, combinations thereof or the like.

Finally, while the bearing shoe 60 is a separate component in the exemplified thrust bearing 100, it is to be appreciated that the bearing shoe can be theoretically built into another component by forming a suitable working surface into one of the other components, such as the leveling plates 30, 40. Such an arrangement, while not preferred, is still considered to be within the scope of the present invention.

Referring now to FIGS. SA-8B concurrently, the base ring 20 of the thrust bearing 100 is illustrated. The base ring 20 acts as a foundation or retaining structure for the components of the thrust bearing 100 described above. The base ring 20 comprises an inner upstanding circular wall 21 and an outer upstanding circular wall 22 arranged in radially spaced apart and concentric manner. The inner wall 21 defines the central opening 10 of the thrust bearing 100. An annular floor plate 23 connects the inner and outer walls 21, 22 so as to form an annular channel 24 having an open top. When the thrust bearing 100 is in an assembled state, the annular channel 24 houses the upper and lower leveling plates 30, 40. The assembly and structural cooperation of the components will be described in greater detail below.

The outer wall 33 of the base ring 20 comprises a first set of threaded holes 25 and a second set of threaded holes 26 for threadily receiving set screws 15, 16 (FIG. 1) respectively. The first and second sets of threaded holes 25, 26 form radial passageways through the outer wall 22 and are circumferentially arranged around the outer wall 22 in a spaced apart and alternating manner. The first set of threaded holes 25 receive the set screws 15 that secure the upper leveling plates 40 within the annular channel 24 of the base ring 20. The second set of threaded holes 26 receive the set screws 16 that secure the lower leveling plates 30 within the annular channel 24 of the base ring 20. The first and second sets of holes 25, 26 are offset from one another. In other words, the first set of holes 25 are at a first height from the bottom of the outer wall 22 while the second set of holes 26 are at a second height from the bottom of the of the outer wall 22. The first height is greater than the second height.

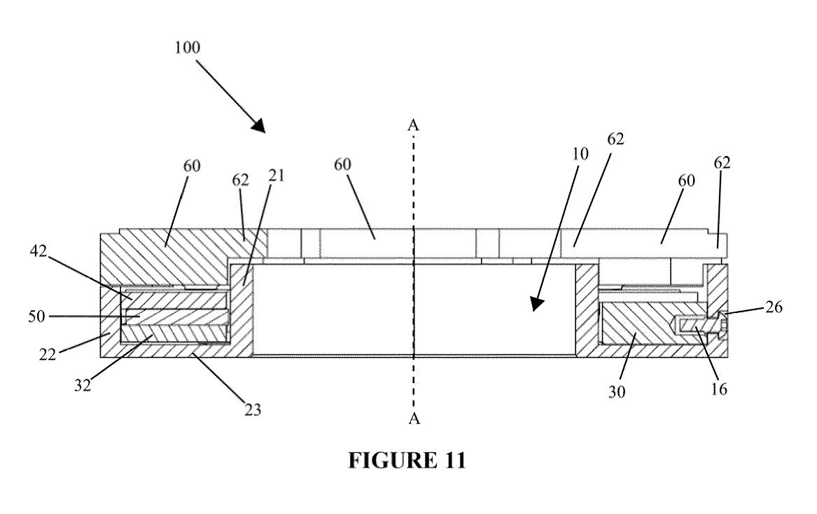

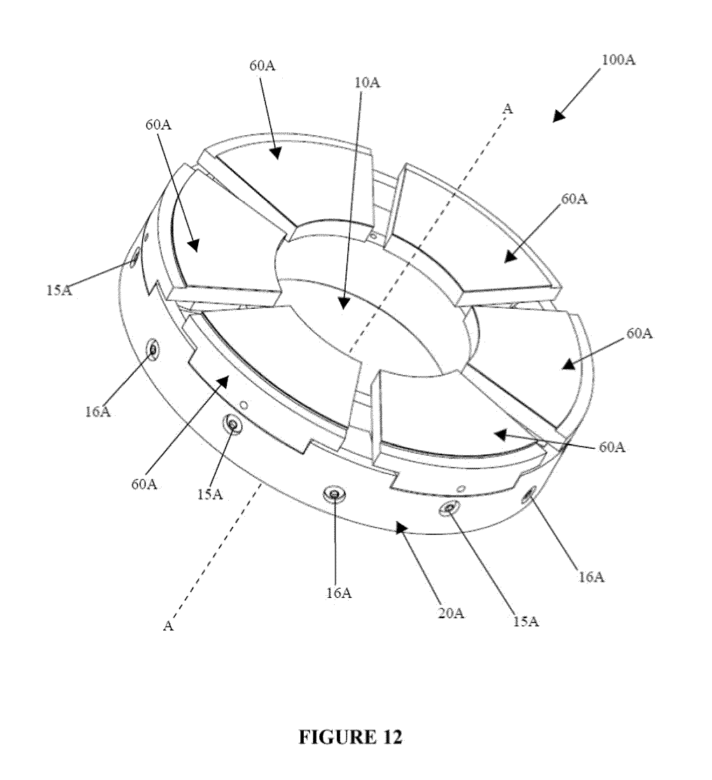

It should be appreciated that the leveling plates 30, 40 may be secured to base ring 20 via other means, such as with integrally formed pins, compressive fitments or any other durable mounting technique that does not affect the necessary tilting action. The outer wall 22 also comprises a plurality of notches 27 formed in to the upper edge of the outer wall 22. The notches 27 are arranged circumferentially around the outer wall 22 in a spaced apart manner. As a result of the spaced apart manner of the notches 27, so as to form protuberances 28 extending from the upper edge of the outer wall 28. The notches 27 are sized to receive the outer portion of the bearing shoes 60 (see FIG. 1). The protuberances 28 circumferentially retain the bearing shoes 60 within the base ring 20 via surface contact with the side walls of the protuberances 28. Referring now to FIG. 10, a top view of the thrust bearing 100 is illustrated in the assembled state. The components of FIG. 10 are not numerically referenced so as to avoid clutter. FIG. 11 illustrates a cross-sectional view along line B-B of FIG. 10 so that the nesting of the rolling pin 50 within the arcuate grooves 39, 49 of the lower and upper leveling plates 30, 40 can be seen in transverse cross-section. FIG. 12 illustrates a cross-sectional view along line A-A of FIG. 10 so that the nesting of the rolling pin 50 within the arcuate grooves 39, 49 of the lower and upper leveling plates 30, 40 can be seen in longitudinal cross-section. FIG. 12 also shows the insertion of one of the set screws 16 into the bore 131 of one of the lower leveling plates 30.

Referring now to FIGS. 1-2 and 11-12 concurrently, the thrust bearing 100 will be described in its assembled state along with the details regarding the mechanism of action and interaction between the rolling pins 50 and the leveling plates 30, 40.

As best visible in FIG. 2, the upper and lower leveling plates 30, 40 are arranged within the channel 24 of the base ring 20 in an alternating manner so as to circumferentially surround the central opening 10. Thought of another way, the upper and lower leveling plates 30, 40 are arranged in an alternating manner so as to form a segmented ring-like assembly 200, which is located within the channel 24.

When arranged in the ring-like assembly 200, the upper and lower leveling plates 30, 40 overlap one another. More specifically, the upper flanges 42 of the upper leveling plates 40 overlap the flanges 32 of the lower leveling plates 30 in a spaced part manner. When so arranged, the bottom surfaces of the upper flanges 42 of the upper leveling plates 40 (which comprises the arcuate grooves 49) oppose the upper surfaces of the lower flanges 32 of the upper leveling plates 32 (which comprises the arcuate grooves 39). The rolling pins 50 are located within the spaces formed between the upper flanges 42 of the upper leveling plates 40 and the lower flanges 32 of the lower leveling plates 30. As will be described in greater detail below, the rolling pins 50 are in rolling contact with the flanges 32, 42 of both the lower and upper leveling plates 30, 40 and maintains the spaces between the two.

When positioned within the annular channel 24 of the base ring 20, the lower leveling plates 30 are tiltably mounted in contact with the floor plate 23 of the base ring by the rocker elements 38. More specifically, the rocker elements 38 are in surface contact with the top surface of the floor plate 23, thereby facilitating the lower leveling plates to tilt/rock within the annular channel 24 using the rocking elements 38 as pivots. To the contrary, when the ring assembly 200 is in the annular channel 24, the upper leveling plates 40 “float” above the floor plate 23 of the base ring 20 through their contact with the rolling pins 50. Stated another way, the rolling pins 50, which rest in the arcuate grooves 39 of the lower leveling plates 30, support the upper leveling plates 40 so that a gap 17 (FIG. 10) exists between the bottom surfaces 44 of the upper leveling plates 44 and the top surface of the floor plate 23 of the base ring 20.

Once the ring assembly 200 is in the annular channel 24 as described above, the set screws 15, 16 (which are engaged with the threaded holes 25, 26) are turned so that they extend into the bores 131 of the lower leveling plates 30 and the notches 141 of the upper leveling plates 40 respectively, thereby securing the lower and upper leveling plates 30, 40 within the annular chamber 24 in their desired locations (see right side of FIG. 11). The tolerances are such that when the lower and upper leveling plates 30, 40 are so secured, the rolling pins 50 can not escape from their position between the lower and upper flanges 32, 42.

Turning now to FIGS. 10 and 11 concurrently, the position, interaction and the improved mechanism of action and design of the rolling pins 50 within the arcuate grooves 39, 49 will be discussed. As can be seen, the rolling pins 50 rest freely within the arcuate grooves 39 of the lower leveling plates 30. In other words, the rolling pins 50 are in rolling contact with the upper surfaces of the flanges 32 of the lower leveling plates 30 that form the arcuate grooves 39. Contemporaneously, the rolling pins 50 are also in rolling contact with the bottom surfaces of the of the flanges 42 of the upper leveling plates 40 that form the arcuate grooves 49.

As mentioned above, the outside surfaces 51 of the rolling pins 50 have a transverse cross-section having a radius of curvature that is substantially less than the radius of curvature of the arcuate grooves 39 of the lower leveling plates 30. In a preferred embodiment, the ratio of radius of curvature of the arcuate grooves 39 of the lower leveling plates 30 to the radius of curvature of the rolling pins 50 is greater than 1.2:1. In a more preferred embodiment, the ratio of radius of curvature of the arcuate grooves 39 of the lower leveling plates 30 to the radius of curvature of the rolling pins 50 is in a range between 1.5:1 to 4.5:1. In a most preferred embodiment, the ratio of radius of curvature of the arcuate grooves 39 of the lower leveling plates 30 to the radius of curvature of the rolling pins 50 is 2:1.

By creating the rolling pins 50 to have a radius of curvature that is substantially less than the radius of curvature of the arcuate grooves in which it rests, rolling contact between the rolling pins 50 and the lower leveling plates 30 is increased and unwanted sliding contact is decreased. Thus, wear on the components is decreased. Finally, it should be noted that the entirety of the arcuate groove's transverse cross-sections do not have to meet the aforementioned criteria so long as the portion of the arcuate groove (or surface of the flange) that is in contact with the rolling pins meets this criteria. Such an arrangement is within the scope of the invention. The aforementioned concepts can also be applied to the arcuate grooves 49 of the upper flanges 42 of the upper leveling pates 40.

Once the ring assembly 200 is in place as discussed above, the bearing shoes 60 are positioned atop the ring assembly in a spaced apart circumferential arrangement that surrounds the central opening 10. Adjacent bearing shoes 60 are separated by gaps 18 so as to allow the bearing shoes 60 to rock/tilt as needed during shaft rotation. The bearing shoes 60 are mounted to the ring assembly 200 via surface contact between the rocker element 74 of the shoe support 70 and the raised surface 48 of the upper leveling plate 40. As mentioned above, the protuberances 28 of the outer wall 22 of the base ring 20 circumferentially retain the bearing shoes 60. The flanges 62 of the bearing shoes 60 extend above the inner wall 21 and outer wall 22 of the base ring 20, thereby limiting the degree to which the bearing shoes 60 can tilt/rock during operation.

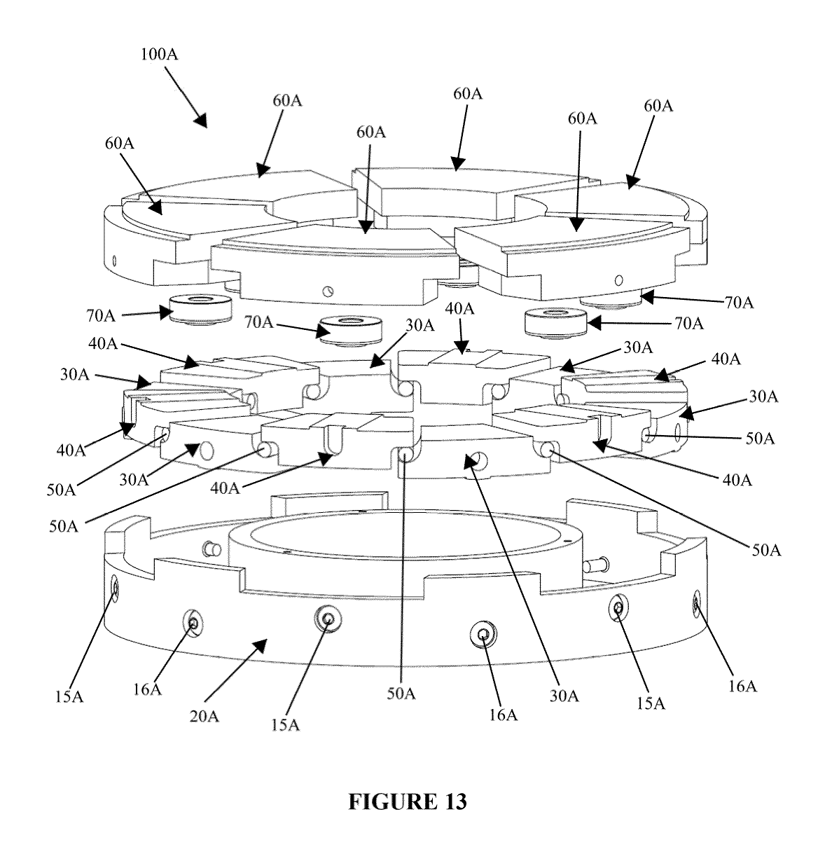

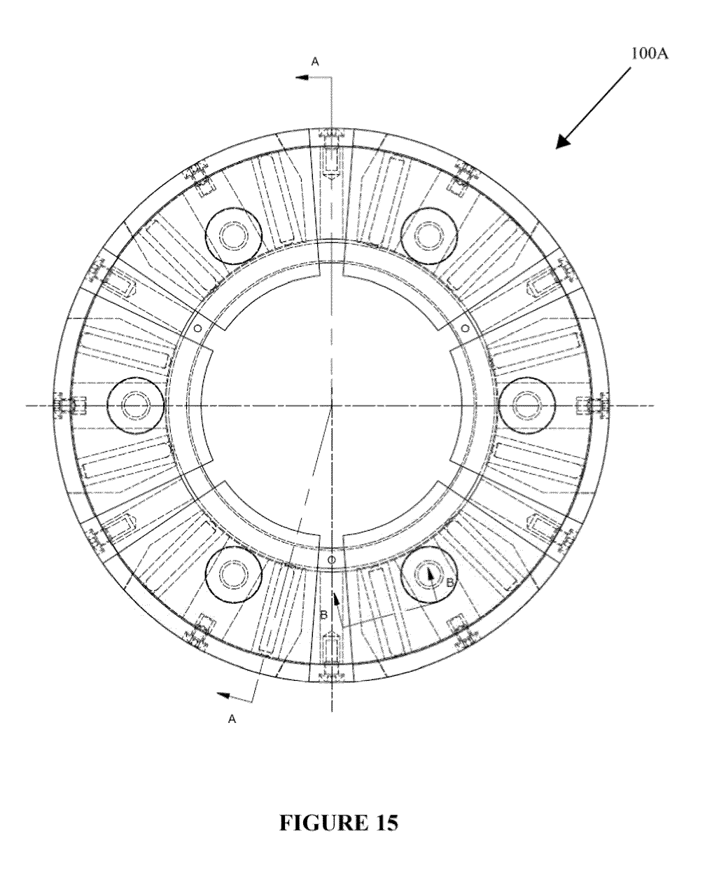

Referring now to FIGS. 12-16 concurrently, a thrust bearing 100A is illustrated according to a second embodiment of the present invention. The thrust bearing 100A is similar to the thrust bearing 100 of FIGS. 1-11 with certain modifications. As such, like numbers will be used to identify like elements, with the exception that the alphabetical suffix “A” will be added to the end of the identifier. In order to avoid redundancy, only those aspects of the thrust bearing 100A that differ from the thrust bearing 100 will be discussed in detail with the understanding the above discussion is applicable.

The major distinguishing characteristic of the thrust bearing 100A from that of the thrust bearing 100 is in the structure of the upper leveling plates 40A, and in particular the upper flanges 42A.

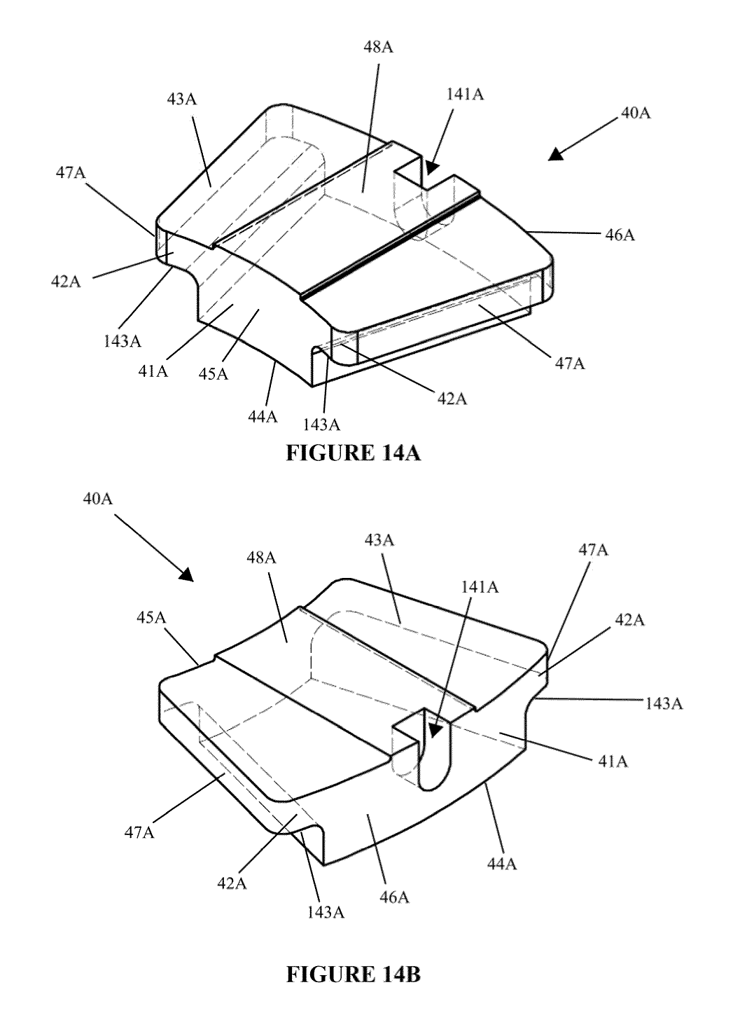

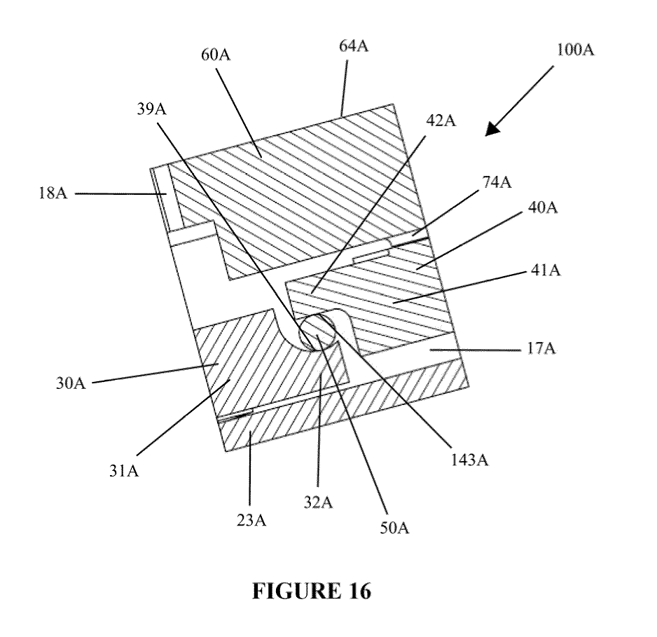

Referring to FIGS. 14A, 14B and 16 concurrently, the upper leveling plates 40A include upper flanges 42A. The upper flanges 42A comprise bottom surfaces 143A which are substantially planar in shape rather than the arcuate grooved shape of the leveling plates 40 of the thrust bearing 100. The substantially planar bottom surfaces 143A of the flanges 42A are the surfaces which make contact with the rolling pins 50A. It has been discovered that by removing the convex curvature from the bottom surfaces 143A of the flanges 42A further reduces wear of the components during use of the thrust bearing 100A. While forming the bottom surfaces 143A of the upper flanges 42A of the upper leveling plates 40A to be substantially planar may constitute the invention in of itself in certain embodiments, it may be preferable to combine the substantially planar bottom surfaces 143A of the upper flanges 42A with the concept discussed above regarding using rolling pins 50A having a radius of curvature that is substantially less than of the arcuate grooves 39A of the lower leveling plates 30A to further minimize wear on all parts. The aforementioned discussion is hereby incorporated by reference for the lower leveling plate 30A as fully set forth herein.

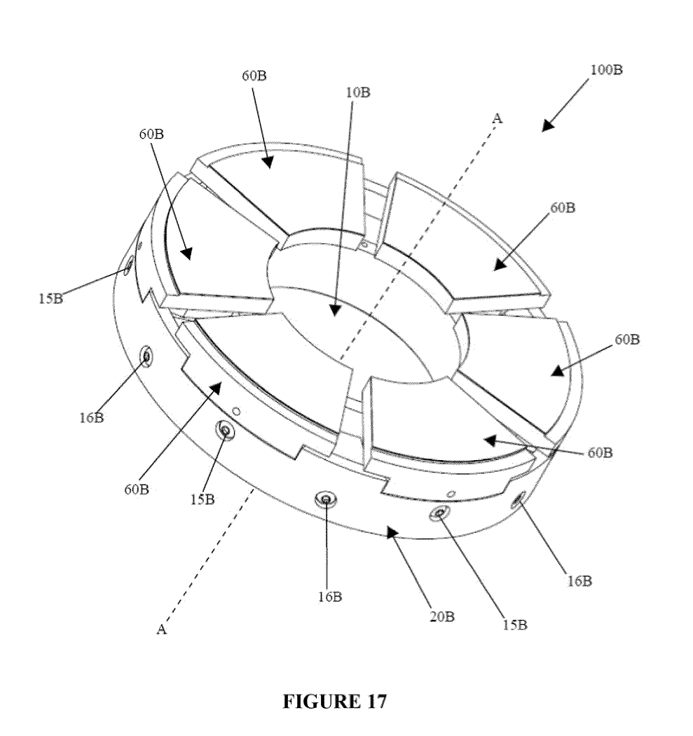

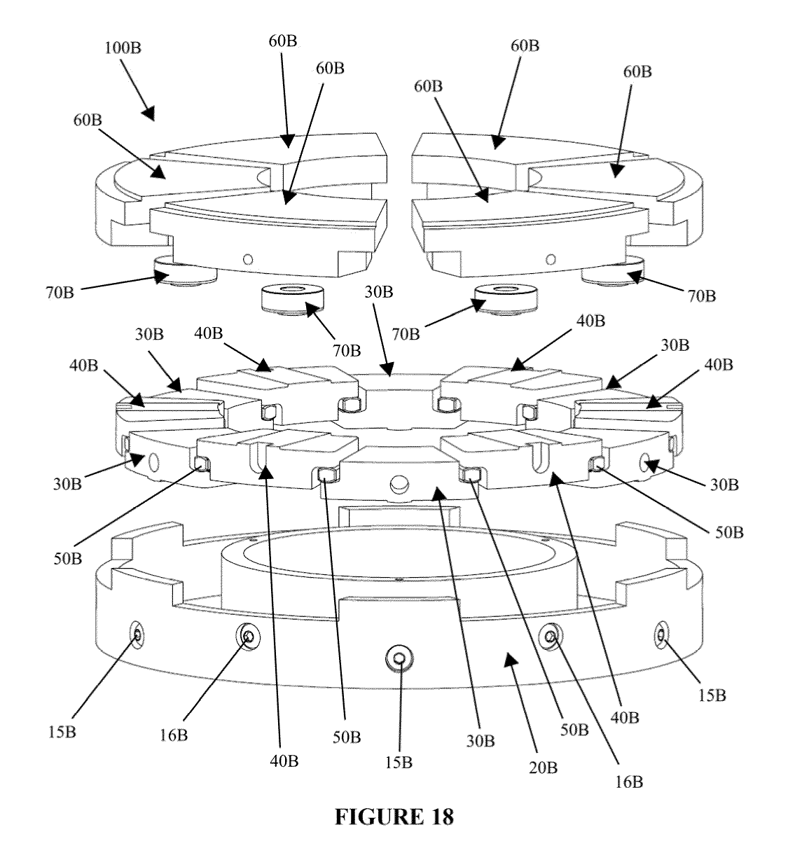

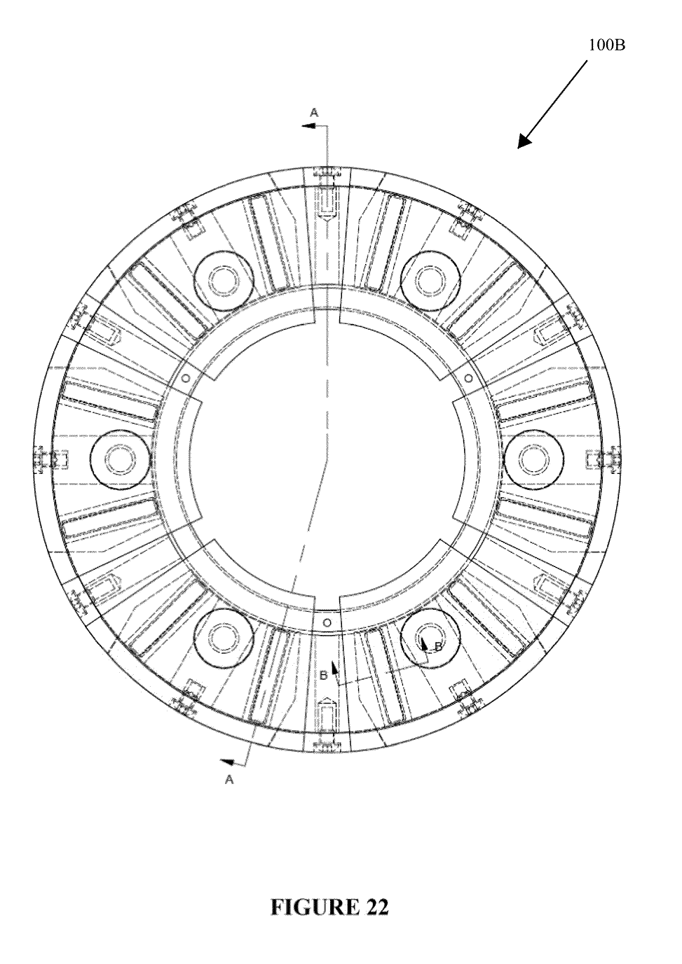

Referring now to FIGS. 17-24 concurrently, a thrust bearing 100B is illustrated according to a third embodiment of the present invention. The thrust bearing 100B is similar to the thrust bearing 100 of FIGS. 1-11 with certain modifications. As such, like numbers will be used to identify like elements, with the exception that the alphabetical suffix “B” will be added to the end of the identifier. In order to avoid redundancy, only those aspects of the thrust bearing 100B that differ from the thrust bearing 100 will be discussed in detail with the understanding the above discussion is applicable.

The major distinguishing characteristic of the thrust bearing 100B from that of the thrust bearing 100 is the shape of the rolling pins 50B. The structure of the upper and lower leveling plates 40B, 30B (in particular the upper and lower flanges 42A, 32A) is also different.

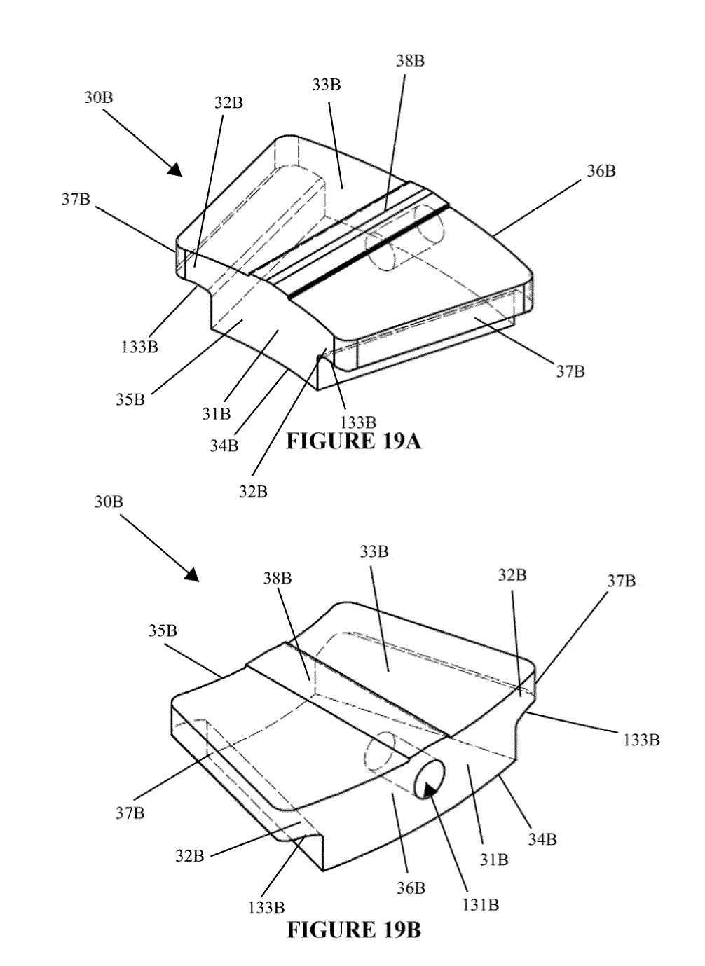

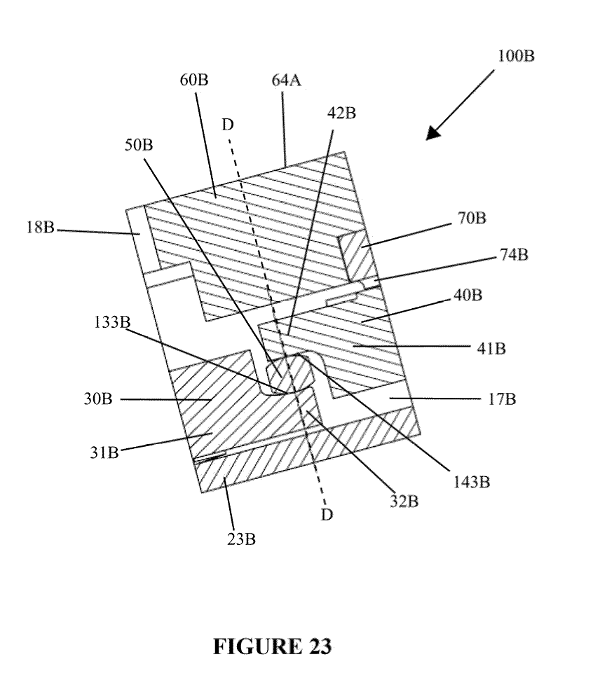

Referring now to FIGS. 19A, 19B and 23 concurrently, the lower leveling plates 30B of the thrust bearing 100B will be discussed. The lower leveling plates 30B comprise a main body 318 and flanges 32B. The flanges 32B comprise upper surfaces 133B which act as the resting surfaces for the rolling pins 50B when the thrust bearing 100B is assembled. The upper surfaces 133B of the flanges are slightly concave so as to form arcuate grooves in which the rolling pins 50B nest. The upper surfaces 133B (and thus the resulting arcuate grooves) have a transverse radius of curvature that is substantially greater than the radius of curvature of tie bottom portion 52B of the outer surface of the rolling pins 50B. The comparative ratios discussed above for the radii of curvature for the thrust bearing 100 can be utilized if desired. However, in some embodiments, the upper surface 133B may be planar if desired and free of an arcuate groove all together. The ratios, in this embodiment, may even be substantially equal if desired.

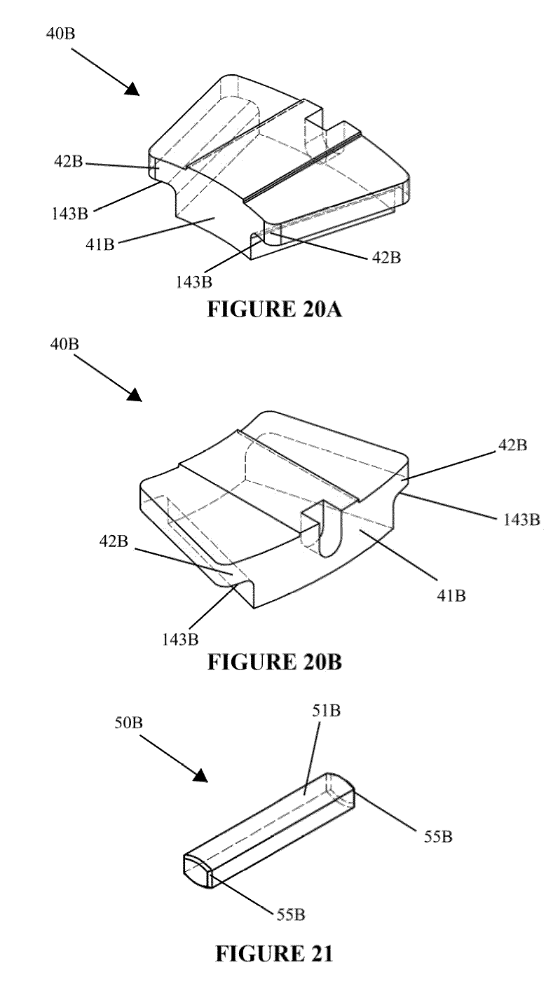

Referring now to FIGS. 20A, 20B and 23 concurrently, the upper leveling plates 40B include upper flanges 42B. The upper flanges 42B comprise bottom surfaces 143B which are substantially planar in shape/contour. The substantially planar bottom surfaces 143b of the flanges 42B are the surfaces which make contact with the top portion 53B of the outer surface of the rolling pins 50B. It has been discovered that by removing the convex curvature from the bottom surfaces 143A of the flanges 42A further reduces wear of the components during use of the thrust bearing 100A. In some embodiment, the bottom surfaces 143A may even have a convex contour.

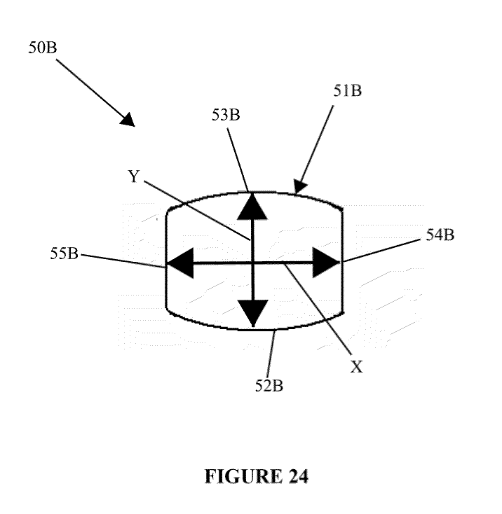

Referring now to FIGS. 21 and 24 concurrently, the rolling pins 50B will now be discussed. The rolling pins 50B are designed to have a specially designed transverse cross-section that reduces the height of the stack formed by the rolling pins and the lower and upper flanges 32B, 42B when the thrust bearing 100B is assembled while still achieving the reduced wear discussed above by utilizing a radius of curvature for those portions of the rolling pins 50B that contact the flanges 32B, 42B. The end portions 55B of the rolling pins 50B are chamfered to eliminate sharp edges that can produce wear over time.

The rolling pins 50B have a transverse cross-section wherein the outer surface 51 has a non-uniform radius of curvature. In the illustrated embodiment, the bottom and top portion 52, 53 of the outer surface 51 are convex surfaces having the same radius of curvature. However, the side portions 54, 55 of the outer surface 51 are planar surfaces that are free of curvature. In essence, the transverse cross-sections of the rolling pins 50B resemble an oval that is truncated at both ends and wherein the sharp corners are then rounded off. In other embodiments, however, the transverse cross-section may take on other shapes.

Thought of another way, the decreased height of the rolling pin 50B can be achieved by creating the transverse cross-section of the rolling pins 50B to have a major axis X and a minor axis Y. The major axis X is greater than the minor axis Y, thereby ensuring that the transverse cross-section is non-circular. The minor axis Y intersects the top and bottom convex portions 52, 53 of the outside surface 51 while the major axis X intersects the lateral planar portions 54, 55 of the outside surface 51. In some embodiments, the transverse cross section may be oval or other flattened arcuate shapes that are (or are not) truncated

Referring now to FIGS. 23 and 24 concurrently, when the thrust bearing 100B is assembled, the rolling pins 50B are freely resting atop the upper surfaces 133B of the lower flanges 32B of the lower leveling pates 30B. More specifically, the convex bottom portions 52B of the rolling pins 50B are in rolling/rocking contact with the upper surfaces 133B of the flanges 32B of the lower leveling plates 30B while the convex top portions 53B of the rolling pins 50B are in rolling/rocking contact with the bottom surfaces 143B of the flanges 42B of the upper leveling plates 40B. When in a resting position, the minor axis Y of the rolling pins 50B is aligned with the axis D-D.

While the invention has been described and illustrated in sufficient detail that those skilled in this art can readily make and use it, various alternatives, modifications, and improvements should become readily apparent without departing from the spirit and scope of the invention.

What is claimed is:

1. A thrust bearing for axially retaining a rotating shaft having a flange comprising:
a base ring having a central opening having an axis;
a plurality of upper leveling plates, each upper leveling plate having a body and upper flanges extending from opposite lateral sides of the body of the upper leveling plate, each of the upper flanges having a bottom surface;
a plurality of lower leveling plates, each lower leveling plate having a body and lower flanges extending from opposite lateral sides of the body, each of the lower flanges having an arcuate groove formed into a top surface of the lower flange, the arcuate channels having a first radius of curvature;
the upper and lower leveling plates arranged in an alternating manner atop the base ring so as to circumferentially surround the central opening so that the upper flanges of the upper leveling plates overlap the lower flanges of the lower leveling plates in a spaced apart manner, the bottom surfaces of the upper flanges opposing the top surfaces of the lower flanges, the lower leveling plates being tiltably mounted to the base ring;
a plurality of rolling pins having a second radius of curvature, the second radius of curvature being substantially less than the first radius of curvature, the rolling pins freely resting within the arcuate grooves of the lower flanges and being in rolling contact with the bottom surfaces of the upper flanges; and
a plurality of shoes having a working surface for bearing contact with the flange of the shaft, the shoes circumferentially surrounding the central opening and located atop the lower and/or upper leveling plates.

2. The thrust bearing of claim 1 wherein the bottom surfaces of the upper flanges are substantially planar and the rolling pins are substantially cylindrical having a circular transverse cross-section.

3. The thrust bearing of claim 1 wherein the ratio of said first radius of curvature to said second radius of curvature is greater than 1.2:1.

4. The thrust bearing of claim 1 wherein the ratio of said first radius of curvature to said second radius of curvature is about 2:1.

5. The thrust bearing of claim 1 further comprising:
said base ring comprising inner and outer concentric walls connected by a floor plate so as to form an annular channel; and
said upper and lower leveling plates positioned within the annular channel of the base ring, the lower leveling plates being tiltably mounted to the floor of the base ring, and the upper leveling plates supported in a spaced manner from the floor plate by the rolling contact with the rolling pins.

6. The thrust bearing of claim 1 further comprising a shoe support positioned between each of the shoes and the upper and/or lower leveling plates, the shoe supports supporting the shoes in a tiltable manner with respect to the upper and/or lower leveling plates.

7. The thrust bearing of claim 1 further comprising:
said base ring comprising inner and outer concentric walls connected by a floor plate so as to form an annular channel;
said upper and lower leveling plates positioned within the annular channel of the base ring; and
wherein the outer wall of the base ring has a top edge comprising a plurality of circumferentially spaced-apart notches, the shoes nesting within the notches and being retained therein through surface contact with the inner and outer walls.

8. The thrust bearing of claim 7 further comprising a plurality of set screws extending through the outer wall of the base ring that secure the upper and lower leveling plates within the annular channel.

9. A thrust bearing for axially retaining a rotating shaft having a flange comprising:
a base ring having a central opening having an axis;
a plurality of upper leveling plates, each upper leveling plate having a body and upper flanges extending from opposite lateral sides of the body of the upper leveling plate, each of the upper flanges having a substantially planar bottom surface;
a plurality of lower leveling plates, each lower leveling plate having a body and lower flanges extending from opposite lateral sides of the body, each of the lower flanges having a groove formed into a top surface of the lower flange;
the upper and lower leveling plates arranged in an alternating manner atop the base ring so as to circumferentially surround the central opening so that the upper flanges of the upper leveling plates overlap the lower flanges of the lower leveling plates so that the substantially planar bottom surfaces of the upper flanges oppose the top surfaces of the lower flanges in a spaced-apart manner, the lower leveling plates being tiltably mounted to the base ring;
a plurality of rolling pins freely resting within the grooves of the lower flanges and being in rolling contact with the substantially planar bottom surfaces of the upper flanges; and
a plurality of shoes having a working surface for bearing contact with the flange of the shaft, the shoes circumferentially surrounding the central opening and located atop the lower and/or upper leveling plates.

10. The thrust bearing of claim 9 wherein the rolling pins have a first transverse radius of curvature and the grooves on the top surfaces of the lower flanges are arcuate grooves having a second transverse radius of curvature, the ratio of said first transverse radius of curvature to said second transverse radius of curvature being about 2:1.

11. The thrust bearing of claim 9 further comprising:
said base ring comprising inner and outer concentric walls connected by a floor plate so as to form an annular channel; and
said upper and lower leveling plates positioned within the annular channel of the base ring, the lower leveling plates being tiltably mounted to the floor of the base ring, and the upper leveling plates supported in a spaced manner from the floor plate by the rolling contact with the rolling pins.

12. The thrust bearing of claim 11 further comprising a shoe support positioned between each of the shoes and the upper and/or lower leveling plates, the shoe supports supporting the shoes in a tiltable manner with respect to the upper and/or lower leveling plates.

13. The thrust bearing of claim 9 further comprising:
said base ring comprising inner and outer concentric walls connected by a floor plate so as to form an annular channel;
said upper and lower leveling plates positioned within the annular channel of the base ring, the lower leveling plates being tiltably mounted to the floor of the base ring, and the upper leveling plates supported in a spaced manner from the floor plate by the rolling contact with the rolling pins;
wherein the outer wall of the base ring has a top edge comprising a plurality of circumferentially spaced-apart notches, the shoes nesting within the notches and being retained therein through surface contact with the inner and outer walls; and
a plurality of set screws extending through the outer wall of the base ring that secure the upper and lower leveling plates within the annular channel.

14. A thrust bearing for axially retaining a rotating shaft having a flange comprising:
a base ring having a central opening having an axis;
a plurality of upper leveling plates, each upper leveling plate having a body and upper flanges extending from opposite lateral sides of the body of the upper leveling plate, each of the upper flanges having a bottom surface;
a plurality of lower leveling plates, each lower leveling plate having a body and lower flanges extending from opposite lateral sides of the body, each of the lower flanges having a top surface;
the upper and lower leveling plates arranged in an alternating manner atop the base ring so as to circumferentially surround the central opening so that the upper flanges of the upper leveling plates overlap the lower flanges of the lower leveling plates so that the bottom surfaces of the upper flanges oppose the top surfaces of the lower flanges in a spaced-apart manner, the lower leveling plates being tiltably mounted to the base ring;
a plurality of rolling pins having a transverse cross section having a major axis and a minor axis, the major axis being greater than the minor axis, the rolling pins positioned between the top surfaces of the lower flanges and the bottom surfaces of the upper flanges, the rolling pins being in rolling contact with the top and bottom surfaces of the lower and upper flanges, and
a plurality of shoes having a working surface for bearing contact with the flange of the shaft, the pads circumferentially surrounding the central opening and located atop the lower and/or upper leveling plates.

15. The thrust bearing of claim 14 wherein the transverse cross section of the rolling pins is a truncated oval shape.

16. The thrust bearing of claim 14 wherein the top surfaces of the lower flanges include an arcuate groove in which the rolling pins freely rest.

17. The thrust bearing of claim 16 wherein the bottom surfaces of the upper flanges include a convex or substantially planar portion in rolling contact with the rolling pins.

18. The thrust bearing of claim 14 wherein the transverse cross sections of the rolling pins have an outer surface having a non-uniform radius of curvature.

19. The thrust bearing of claim 14 further comprising:
wherein the transverse cross sections of the rolling pins have an outer surface having a non-uniform radius of curvature;
said base ring comprising inner and outer concentric walls connected by a floor plate so as to form an annular channel;
said upper and lower leveling plates positioned within the annular channel of the base ring, the lower leveling plates being tiltably mounted to the floor of the base ring, and the upper leveling plates supported in a spaced manner from the floor plate by the rolling contact with the rolling pins;
wherein the outer wall of the base ring has a top edge comprising a plurality of circumferentially spaced-apart notches, the shoes nesting within the notches and being retained therein through surface contact with the inner and outer walls; and
a plurality of set screws extending through the outer wall of the base ring that secure the upper and lower leveling plates within the annular channel.

20. The thrust bearing of claim 14 wherein the transverse cross-sections of the rolling pins comprise convex top and bottom portions and substantially planar lateral portions.

21. A thrust bearing for axially retaining a rotating shaft having a flange comprising:
a base ring having a central opening having an axis;
a plurality of upper leveling plates, each upper leveling plate having a body and upper flanges extending from opposite lateral sides of the body of the upper leveling plate, each of the upper flanges having a bottom surface;
a plurality of lower leveling plates, each lower leveling plate having a body and lower flanges extending from opposite lateral sides of the body, each of the lower flanges having a top surface;
the upper and lower leveling plates arranged in an alternating manner atop the base ring so as to circumferentially surround the central opening so that the upper flanges of the upper leveling plates overlap the lower flanges of the lower leveling plates so that the bottom surfaces of the upper flanges oppose the top surfaces of the lower flanges in a spaced-apart manner, the lower leveling plates being tiltably mounted to the base ring;
a plurality of rolling pins having a transverse cross section having an outside surface having a non-uniform radius of curvature, the rolling pins positioned between the top surfaces of the lower flanges and the bottom surfaces of the upper flanges, the rolling pins being in rolling contact with the top and bottom surfaces of the lower and upper flanges; and
a plurality of shoes having a working surface for bearing contact with the flange of the shaft, the pads circumferentially surrounding the central opening and located atop the lower and/or upper leveling plates.

22. The thrust bearing of claim 20 wherein the transverse cross sections of the rolling pins are a truncated oval shape, wherein curved portions of the truncated oval shapes contact the top and bottom surfaces of the lower and upper flanges.
